(19) United States
(12) Patent Application Publication
(10) Pub. No.: US 2010/0010975 A1
(43) Pub. Date: Jan. 14, 2010

(54) Methods And Systems For Resolving A Query Region To A Network Identifier

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/170,833

(22) Filed: Jul. 10, 2008

(51) Int. Cl. G06F 7/06; G06F 17/30

(52) U.S. Cl. 707/4; 707/E17.014

(57) ABSTRACT

A method for resolving a query region to a network identifier includes receiving, at a multicast server associated with a domain region, a network identifier identifying a node having a node region at least partially present in the domain region. The method includes receiving a query identifying a query region. The method includes determining that the domain region is at least partially present in the query region. The method includes sending the network identifier in response to the determination. In another embodiment, a method includes receiving location information identifying a query region, and generating a query identifying the query region. The method includes sending the query to a multicast server associated with a domain region at least partially present in the query region. The method includes receiving a response including a network identifier identifying a node having a node region at least partially present in the domain region.

### RELATED APPLICATIONS

This application is related to the following commonly owned U.S. patent applications, the entire disclosure of each being incorporated by reference herein:

Application Ser. No. ______ (Attorney Docket No I522/US) filed on even date herewith, entitled “METHODS AND SYSTEMS FOR RESOLVING A GEOSPATIAL QUERY REGION TO A NETWORK IDENTIFIER”; and

Application Ser. No. ______ (Attorney Docket No I523/US) filed on even date herewith, entitled “METHODS AND SYSTEMS FOR RESOLVING LOCATION INFORMATION TO A NETWORK IDENTIFIER”.

### BACKGROUND

In the current domain name system (DNS), a query identifying a region for returning a network identifier of a node associated with the region is not supported. In the current system, performing such a query is impractical. Region information is associated with a node in DNS currently by a LOC record as defined in the Internet Engineering Task Force (IETF) Request for Comments (RFC) 1876. A LOC record is managed by a DNS server representing for a DNS naming domain, such as “example.com”. A LOC record allows an IP address to be resolved to a location/region. A DNS server representing a specified name domain can include LOC records from any number of regions. LOC records for any given region can be distributed across the DNS, and thus may be located on any number of DNS servers. That is, there is no DNS server that is authoritative or responsible for a specified region.

Further, applications, such as browsers, often need to know more than a host network address. For example, a browser requires a Uniform Resource Locator (URL) for identifying a service accessed by a host network address. Current DNS provides service records for locating services of various types in a given non-geospatial domain. A DNS naming domain can span more than one subnet and can span multiple, disjoint geospatial regions. There is no standard way of locating a service in a specified geospatial region.

Accordingly, there exists a need for methods, systems, and computer program products for resolving a query region to a network identifier.

### SUMMARY

Methods and systems are described for resolving a query region to a network identifier. In one embodiment, a method includes receiving, at a multicast server associated with a domain space including a domain having a domain region, a network identifier identifying a node having a node region at least partially present in the domain region. The method also includes receiving, at the multicast server, a query identifying a query region. The method further includes determining that the domain region is at least partially present in the query region. The method still further includes sending the network identifier in response to the determination.

In another embodiment, the method includes receiving location information identifying a query region. The method also includes generating a query identifying the query region. The method further includes sending the query for routing to a multicast server associated with a domain space including a domain having a domain region at least partially present in the query region. The method still further includes receiving a response including a network identifier identifying a node having a node region at least partially present in the domain region.

According to an aspect, a system for resolving a query region to a network identifier includes a group manager component configured to receive, at a multicast server associated with a domain space including a domain having a domain region, a network identifier identifying a node having a node region at least partially present in the domain region. The system also includes a resolution service component configured to receive, at the multicast server, a query identifying a query region. The system further includes a matcher component configured to determine that the domain region is at least partially present in the query region. The method still further includes a message-out handler component configured to send the network identifier in response to the determination.

According to an aspect, a system for identifying a node having a node region at least partially present in a domain region includes a resolver interface component configured to receive location information identifying a query region. The system also includes a multicast resolver component configured to generate a query identifying the query region. The system also includes a multicast client component configured to send the query for routing to a multicast server associated with a domain space including a domain having a domain region at least partially present in the query region. The system also includes a multicast client component configured to receive a response including a network identifier identifying a node having a node region at least partially present in the domain region.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for resolving a query region to a network identifier according to an embodiment of the subject matter described herein;

FIG. 2 is a block diagram illustrating a system for resolving a query region to a network identifier according to another embodiment of the subject matter described herein;

FIG. 3 is a block diagram illustrating a system for resolving a query region to a network identifier according to another embodiment of the subject matter described herein;

FIG. 4 is a message flow diagram illustrating a message flow for resolving a query region to a network identifier according to another embodiment of the subject matter described herein;

FIG. 5 is a flow diagram illustrating a method for resolving a query region to a network identifier according to another embodiment of the subject matter described herein;

FIG. 6 is a block diagram illustrating a system for resolving a query region to a network identifier according to another embodiment of the subject matter described herein; and

FIG. 7 is a block diagram illustrating a system for resolving a query region to a network identifier according to another embodiment of the subject matter described herein.

### DETAILED DESCRIPTION

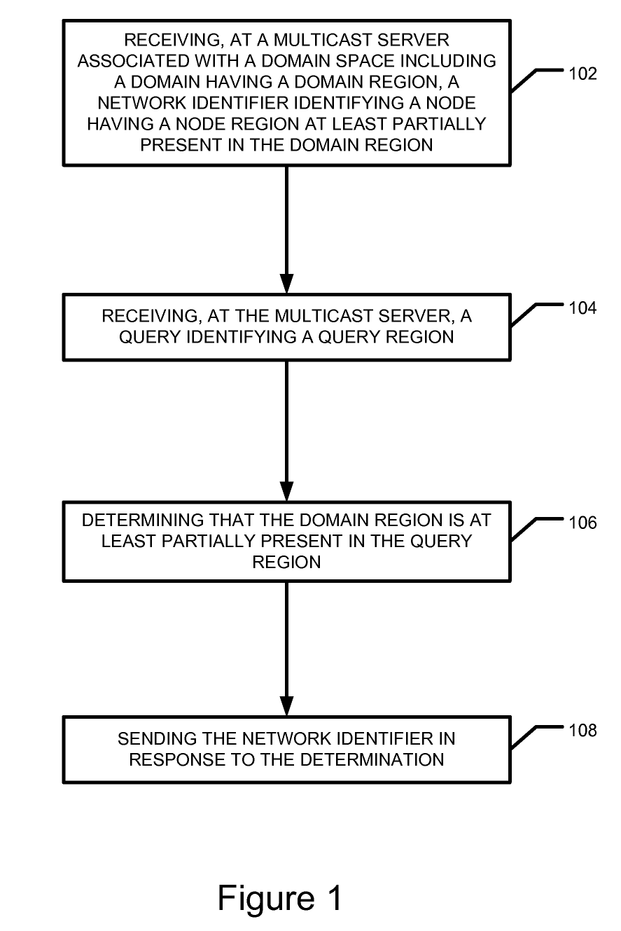

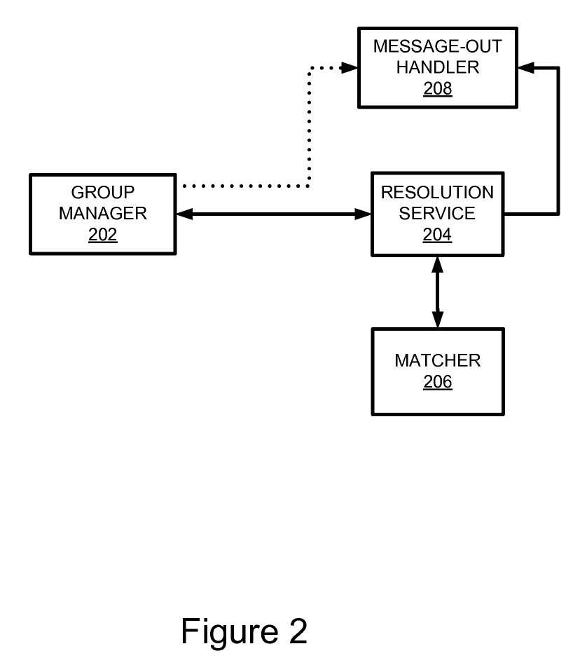

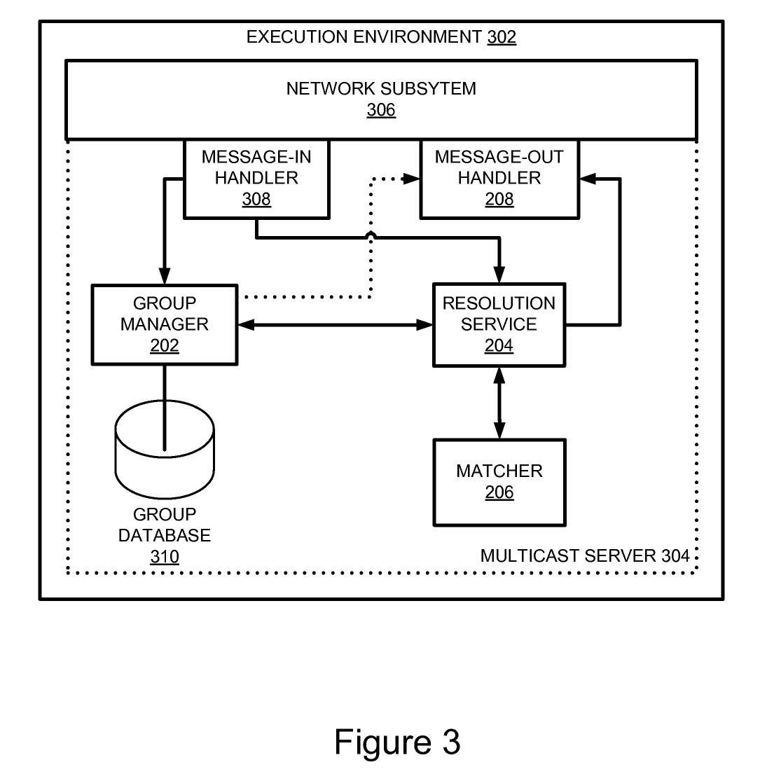

FIG. 1 is a flow diagram illustrating a method for resolving a query region to a network identifier according to an exemplary embodiment of the subject matter described herein. FIG. 2 is a block diagram illustrating an arrangement of components for resolving a query region to a network identifier according to another exemplary embodiment of the subject matter described herein. FIG. 3 is a block diagram illustrating an arrangement of components providing an execution environment configured to host the arrangement of components illustrated in FIG. 2. The method illustrated in FIG. 1 can be carried out by, for example, some or all of the components illustrated in FIG. 2, operating in a compatible execution environment, such as the environment illustrated in FIG. 3.

With reference to FIG. 1, in block 102 a multicast server associated with a domain space including a domain having a domain region receives a network identifier. The network identifier identifies a node having a node region at least partially present in the domain region. A multicast server is a service for the delivery of information to a group of destinations simultaneously using the most efficient strategy to deliver the messages over each link of the network only once, creating copies only when the links to the destinations split.

A domain can have a geospatial region associated with the domain, referred to herein as a domain region. The association between a domain and a domain region can be based on a relationship between the domain region and the domain and/or a node having a network identifier in the domain. The relationship can be of any type, be unidirectional or bidirectional, and can have cardinality. For example, a domain can represent a geospatial region as its domain region and/or one or more nodes in the domain can be included in and/or otherwise represent the domain region of the domain. Further, the relationship associating a domain with a domain region can be of a type based on at least one of an owner, a user, an administrator, a purchase of, a legal right associated with, an authentication service for, an authorization service for, a signer of a digital certificate for one or more of the domain, a node in the domain, and the domain region.

Accordingly, a system for resolving a query region to a network identifier includes means for receiving, at a multicast server associated with a domain space including a domain having a domain region, a network identifier identifying a node having a node region at least partially present in the domain region. For example, as illustrated in FIG. 2, a a group manager component 202 is configured to receive, at a multicast server associated with a domain space including a domain having a domain region, a network identifier identifying a node having a node region at least partially present in the domain region.

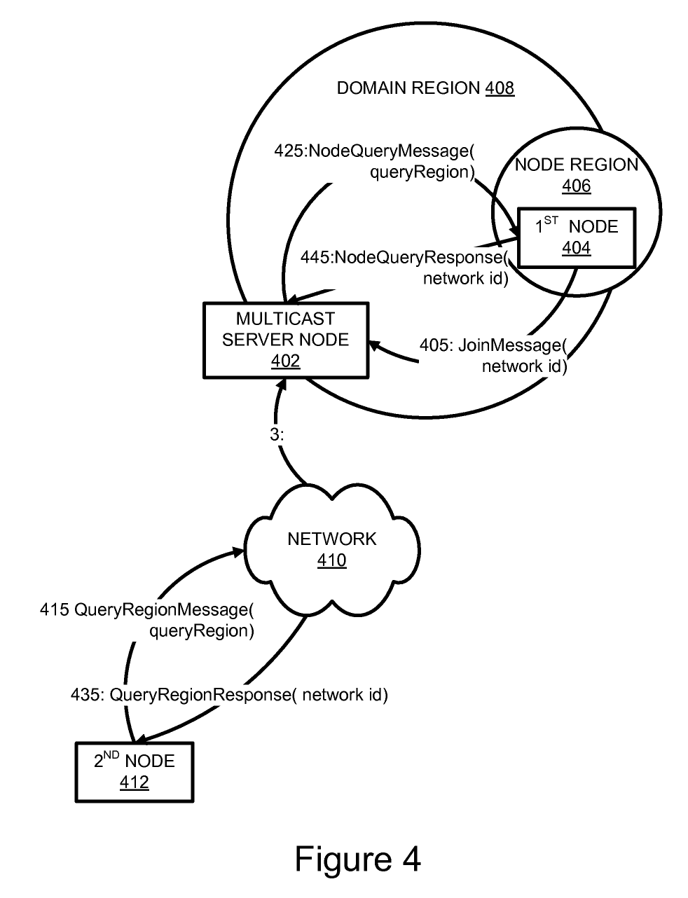

The group manager component 202 and the other components illustrated in FIG. 2 can operate in an execution environment 302 as illustrated in FIG. 3. The execution environment 302 as illustrated includes the components of FIG. 2 in an exemplary multicast server 304, hosted by a multicast server node 402 illustrated in FIG. 4. The multicast server 304 includes multiple components that are not required by a multicast server according to an embodiment. As stated above, the group manager component 202 receives a network identifier. For example, the network identifier can be a network identifier such as a network address and/or network name of a first node 404.

A network identifier is a logical identifier for a communication endpoint on a network. A network identifier includes at least one of a node portion identifying a node having a network interface in an identifiable portion of network and a domain portion identifying the identifiable portion of the network. Network identifiers are described in more detail below. A node can be any device having a network interface such as, for example, an Ethernet NIC and/or a wireless adapter.

An Internet Protocol (IP) address is a network identifier for communicating over an IP network such as the Internet. The domain name system (DNS) includes a set of names that include network identifiers. The DNS system is configured to map a DNS name to a network address. A network identifier can be at least one of a network address and a symbolic identifier of a network address, such as a DNS name. A network address is a network layer address identifier for a network interface (unicast) or a set of interfaces (multicast or broadcast).

A network address, such as an Internet Protocol (IP) address, can include a domain portion referred to as a subnet ID. For example, the partial IP address, 162.195.20, is a domain portion of an IP address that identifies a subnet including nodes with network addresses that begin with the IP address prefix 162.195.20. To more precisely identify a subnet an IP address or a portion of an IP address can be associated with a mask, such as 255.255.255.0, the mask identifies the subnet portion of an IP address via a logical “or” operation performed between each pair of bits identified by bit position in an IP address and the mask.

Analogously, a network name identifying a node, such as a DNS name, can include a domain portion identifying a portion of a network. For example, “nc.sceneralabs.com”, can identify a naming domain where a network interface of a node in the naming domain is associated with a name such as, “placid”. The name “placid” identifies the network interface of the node within the naming domain. The complete network name, “placid.nc.sceneralabs.com”, identifies the node when used outside the naming domain.

As discussed above, a network identifier includes a node portion that identifies a node having a network interface in a portion of the network identified by a domain portion. For example, in an IP address, a portion of the address is associated with a particular network interface in the identified subnet, thus identifying the network interface of the node. In the IP address 162.195.20.143 in the subnet 162.195.20.0/255.255.255.0, 143 is the node portion identifying a node have a network interface in the subnet. A subnet is a domain in the network address domain space. In a DNS name the first portion of the name identifies a node having a network interface in an identifiable domain in the DNS name domain space. As indicated, “placid” is the node portion identifying a network interface in the naming domain identified by “nc.sceneralabs.com”, and “placid.nc” is the node portion in a parent naming domain identified by the domain portion, “sceneralabs.com”.

There can be a one to one correspondence between a subnet in a network address domain space and a domain in a naming domain space, but a one to one correspondence is not required. For example, a domain in a naming domain space can be associated with one or more subnets or network portions. Further, a subnet can include network interfaces of nodes included in a single domain of a naming domain space or included in more than one naming domain in a naming domain space.

A domain space can include one or more nodes having network identifiers from the domain name space. A domain portion of a name from the domain name space, a portion of a network identified by the domain portion, a node portion of the name, and a node identified by the name can be said to be “in” and “included in” the domain space. Further, an identified portion of the network can be referred to as the domain. The node portion of the name, a network interface of the node identified by the node portion, and the node can be said to be “in” and “included in” the domain identified by the domain portion.

Analogously, a subnet portion of a network address from a domain address space, a portion of a network identified by the subnet portion, a node portion of a network address, and the node identified by the network address can be said to be “in” and “included in” a domain space. Further, an identified portion of the network can be referred to as the domain and/or subnet. The node portion of the network address, a network interface of the node identified by the node portion, and the node can be said to be “in” and “included in” the domain and/or subnet identified by the subnet portion.

Referring again to FIG. 4, the first node 404 has a node region 406 that is at least partially present in a domain region 408. The multicast server node 402 represents a first domain in first domain space. The first domain identifies the domain region 408. At least a node portion of a network identifier of the first node 404 can be received, for example, in a join message, such as a join message 405 sent from the first node 404 to the multicast server node 402 via a portion of a network 410.

The join message 405 can be received by the group manager component 202 via a network subsystem 306 of the execution environment 302. A message-in handler component 308 of the messaging service can be configured to receive messages such as the join message 405 from the network subsystem 306. The message-in handler 308 can be further configured to route received messages to components of the multicast server 304 for processing based on an attribute of each message, such as a message identifier and/or a detected format. The join message 405 can be for joining any multicast group maintained by the group manager component 202.

In another aspect, a join message can identify a resolution group for resolving the query region to the network identifier. In FIG. 3, the group manager component 202 is illustrated as adapted for operating in the execution environment 302 and can maintain groups in a database, referred to as a group database 310, in the execution environment 302. Alternatively or additionally, the group manager component 202 can be configured to maintain a specific group referred to as the resolution group. The resolution group is for maintaining a membership for the first node 404 and any other node having a node region at least partially present in the domain region 408. The network identifier can be at least one of included and received with an identifier of the node region 406. Additionally or alternatively, the group manager component 202 can provide for performing a lookup operation for determining a node region of a joining node.

For example, a DNS server can receive a query including a network identifier to be sent from a component of the multicast server 304, such as a resolution service component 204, via a DNS client (not shown) operating in the execution environment 302. The DNS server can be configured to determine whether location information specifying a node region of a node identified by the network identifier is maintain in a LOC record associating a network address of the node with the location information. When an association is detected, the location information identifying the node region can be returned to the multicast server 304. The node region identifier can be provided to the resolution service component 204. According to an aspect, the resolution service 204 can be hosted on a node, such as the multicast server node 402, configured to host the multicast server 304. The resolution service component 204 can invoke a matcher component 206 that is configured to determine whether the identified node region is at least partially present in the domain region 408. When the node region 406 is at least partially present in the domain region 408, control returns to the group manager component 202 for placing the identified node in the resolution group or an analog.

Alternatively or additionally, the first node 404 can be configured to determine that its node region 406 is at least partially present in the domain region 408 of the multicast server 304 in the multicast server node 402. The join message 405 can be sent based on this determination. The first node 404 can send a message to any multicast server node allowing the receiving multicast server node to make the determination

As discussed above, the group manager component 202 and other components in FIG. 2 can be adapted for operating in a number of execution environments, such as an execution environment 302 illustrated in FIG. 3 For example, a typical execution environment can include a memory for storing instructions and data, a processor for processing the instructions and data, a control program or operating system for managing the memory and processor making the instructions and data accessible to the processor. The execution environment 302 can include other subsystems required by the components of FIG. 2 for any particular configuration. For example, the execution environment 302 can include a network subsystem 306 for providing network communications in interoperation with at least some of the components operating in the execution environment. Execution environments can be provided by a node or a distributed execution environment can be provided by a collection of nodes. As indicated, the first node 404 can be configured to provide the execution environment 302 hosting the components of FIG. 2.

Returning to FIG. 1, in block 104 a query identifying a query region is received at the multicast server. Accordingly, a system for resolving a query region to a network identifier includes means for receiving, at the multicast server, a query identifying a query region. For example, as illustrated in FIG. 2, a resolution service component 204 is configured to receive, at the multicast server, a query identifying a query region. FIG. 2 illustrates the resolution service component 204 configured to receive a query identifying a query region. According to an aspect, the resolution service component 204 is illustrated as included in the multicast server 304 in FIG. 3.

Referring now to FIG. 4, a second node 412 can send a query region message 415 for routing via the network 410 to the multicast server 304 operating in the execution environment 302 hosted by the multicast server node 402. According to an aspect, the query region message 415 can include a geospatial identifier identifying a query region. A geospatial identifier includes any identifier that includes a portion that is usable for identifying a region/location of a geospatial domain space. Examples include:

postal://usa.nc.cary.corning-road:111.suite:220.placid

postal://placid.suite:220.corning_road:111.cary.nc.usa

postal://placid.suite:220:corning_road:111.27518.

Each of the above examples is from a geospatial domain space based the US Post Office geospatial domain space that includes postal addresses.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined for specifying regions and locations having a variety of shapes such as a rectangle, circle, oval, or any shape including a closed region. A geospatial identifier can identify a region with disjoint sub-regions by including a geospatial attribute that identifies the sub-regions. For example, the identifier, “40+”, from an domain space including average annual rainfall totals over a specified period identifies a geospatial region including all sub-regions that have an average annual rainfall over 40 inches.

The query region identifier can be included in a network identifier, such as at least one of a portion of a network address and a network name. Alternatively or additionally, the query region can be identified based on any suitable region identifier including those described above with respect to geospatial identifiers. The second node 412 can determine a network address of the multicast server node 402 in a number of ways described in detail below in the discussion of the sender of the query region message 415. For example, in an aspect, the query can include a multicast server identifier identifying the multicast server. In another aspect, the query can include a multicast group identifier identifying a resolution service for processing the query.

According to an aspect, the query can be included in an asynchronous message. Asynchronous messages can be included in a publish-subscribe system. A presence protocol is a specialized publish-subscribe protocol including a status field. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. While the various presence aware IM applications described above may user proprietary architectures and protocols to implement their presence service components, each of the applications use presence architectures and protocols that are consistent with the presence model and protocols described in RFC 2778 and RFC 2779 in terms of features and function. In another aspect, the query message is formatted according to a domain name system (DNS) protocol or an analog and the resolution service includes a network directory service.

Returning to FIG. 1, in block 106 it is determined that the domain region is at least partially present in the query region. Accordingly, a system for resolving a query region to a network identifier includes means for determining that the domain region is at least partially present in the query region. For example, as illustrated in FIG. 2, a matcher component 206 is configured to determine that the domain region is at least partially present in the query region.

The resolution service component 204 can be configured to identify the query region to the matcher component 206. The matcher component 206 is illustrated in FIG. 3 as configured to determine whether the domain region is at least partially present in the query region. When the matcher component 206 determines that the domain region is at least partially present in the query region, the resolution service component 204 is notified. When the matcher component 206 determines the two regions do not overlap, the processing of the query can be halted. Alternatively, in response to the determination by the matcher component 206 that the two regions do not overlap, the resolution service component 204 can be configured to interoperate with a message-out handler component 208 for generating a query response. The query response can include an indication that two regions do not overlap and/or an error indication of some type

In another aspect, determining that the domain region is at least partially present in the query region can include routing, based on the multicast group identifier, a node query message to an external resolution service (not shown) operating in another execution environment hosted by another node. Determining that the domain region is at least partially present in the query region can further include receiving, from the external resolution service, a node query response identifying the node. For example, the resolution service component 204 component can be configured to route, based on the multicast group identifier, a node query message to the external resolution service, and receiving, from the external resolution service, a node query response identifying the node. The external resolution service can operate in, for example, in one or more client nodes of the multicast server node 402, such as the first node 404.

In another aspect, determining that the domain region is at least partially present in the query region can include determining an external resolution service based on the query region message, routing a node query message to the external resolution service for determining whether the domain region is at least partially present in the query region, and receiving a node query response identifying the node. For example, the resolution service component 204 component can be configured to determine an external resolution service based on the query region message, routing a node query message to the external resolution service for determining whether the domain region is at least partially present in the query region, and receiving a node query response identifying the node.

For example, the resolution service component 204 can interoperate with the group manager component 202 for sending a node query message to each identified node in the domain known to the group manager component 202. For example, the resolution service component 204 can invoke the group manager component 202 to send a node query message to each node in domain, such as the node query message 425 sent the first node 404 hosting a resolution service external to the multicast server 304. The node query message 425 can be sent by the message-out handler component 208 via the network subsystem 306. The generation of the node query message 425 can be performed by one or both of the group manager component 202 and the message-out handler component 208. The first node 404 can receive the domain region in the node query message 425. The first node 404 can determine the domain region based on a network identifier of the multicast server node 402. The first node 404 can receive the domain region in another message from the multicast server node 402 such as a response (not shown) to the join message 405.

Alternatively or in addition, the first node 404 can query a lookup service (not shown) such as network directory system (NDS) such as a DNS server for retrieving information associated with a network identifier of the multicast server node 402 that identifies the domain region. The first node 404 can include a component for determining whether the domain region 408 is at least partially present in the query region.

In another aspect, determining that the domain region is at least partially present in the query region includes determining that the query region is at least partially present in the node region. For example, the resolution service component 204 component can be configured to determine that the domain region 408 is at least partially present in the query region includes determining that the query region is at least partially present in the node region 406. Alternatively or additionally, the first node 404 can include a component for determining whether the node region 406 is at least partially present in the query region, thus indirectly determining that the domain region 408 is at least partially present in the query region.

Returning to FIG. 1, in block 108 the network identifier is sent in response to the determination. Accordingly, a system for resolving a query region to a network identifier includes means for sending the network identifier in response to the determination. For example, as illustrated in FIG. 2, a message-out handler component 208 is configured to send the network identifier in response to the determination.

Referring to FIG. 2 and FIG. 4, in response to at least one of the matcher component 206 and a matcher component operating in an execution environment of a node, such as the first node 404, determining that the domain region 408 is at least partially present in the query region, one or more network identifiers of nodes in the domain are sent in a query region response 435 by the message-out handler component 208 in response to the query region message 415.

For example, the resolution service component 204, in response to the determination by the matcher component 206, can provide an indication to the group manager component 202 to send the network identifier of the node in the domain in the query region response 435. The group manager component 202 can include all network identifiers it maintains, for example, in a resolution group in the group database 310. The group manager component 202, interoperating with the message-out handler component 208, can generate the query region response 435 including the network identifiers. The message-out handler component 208 can be configured to send the one or more network identifiers. The message-out handler component 208 can be configured to send the query region response 435 to the second node 412 via the network subsystem 306 over the network 410 from the multicast server node 402.

According to an alternative aspect described above, one or more nodes in the domain, such as the first node 404, can be configured to send a node query response to multicast server 304 in the multicast server node 402. Each node query response can include at least one of an indication that the domain region 408 is at least partially present in the query region or an indication that the node region 406 is at least partially present in the query region. Node query responses can be received by the message-in handler component 308 illustrated in FIG. 3. The message-in handler component 308 can be configured to route node query response information to the resolution service component 204. Based on the responses, the resolution service component 204 can interoperate with the message-out handler component 208 for generating at least one query region response. If multiple query region responses are generated, then each query region response will identify one or more network identifiers in the domain. The generated query region responses can be sent to the second node 412 by the message-out handler component 208 as described above. Additionally or alternatively, at least one of the matcher component 206 and a matcher component in the first node 404 can be configured to determine whether the node region 406 of the first node 404 is at least partially present in the query region.

The matcher component 206 and a matcher component in the first node 404 can each be configured to indicate a network identifier is to be sent when the node region 406 is at least partially present in the query region. This requirement can be in addition to, or instead of, determining that the domain region 408 is at least partially present in the query region. The resolution service component 204, the group manager component 202, and the message-out handler component 208 can send one or more query region responses to the second node 412 including one or more network identifiers where each node region of the one or more identified nodes is at least partially present in the query region. The query region response 435 can be sent analogously to sending a node query response 445, as described in the alternatives described above.

In a further alternative (or in addition to), a matcher component included in a node, such as the first node 404, can interoperate with a message-out handler component operating in an execution environment of the first node 404. The matcher component can interoperate with the message-out handler component to generate a node query response 445 as described. The message-out handler component of the first node 404 can be configured to send the node query response 445 addressed to the second node 412. As already described, the node query response 445 including the network identifier of the first node 404 can be sent by the message-out handler component of the first node 404 in response to determining that one or both of the domain region 408 and the node region 406 are partially present in the query region.

Additional attributes, such as a matching criterion, for determining the network identifier for sending in response to the query region message 415 can be at least one of included in the query region message 415 and accessible to one or both of the multicast server 304 and the first node 404 for determining whether a network identifier is to be sent in response.

For example, the query region message 415 can include a node portion of a network identifier of a node in at least one of an address format and as a symbolic name associated with an address. The group manager component 202 can be configured to maintain at least node portions of network identifiers for each node in the domain. The matcher component 206 can be configured to determine whether a node portion of a network identifier of a node in the domain matches the node portion included in the query region message 415. The query region response 435 can be generated by the multicast server 304 that includes only network identifiers that have a matching node portions (can be network interface expression for matching) in addition to determining that at least one of the domain region 408 and the node region 406 is at least partially present in the query region. Additionally or alternatively, the first node 404 matcher component can determine whether the received node portion matches an identifier of a network interface of the first node 404. The first node 404 can send a node query response 445 to the multicast server 304 in the multicast server node 402 and/or send a node query response 445 addressed to the second node 412 that sent the query region message 415.

Other attributes, such as a matching criterion, can be included in the query region message 415 and/or processed as configuration data by the multicast server 304 and/or a node in the domain such as the first node 404. For example, the multicast server 304 can be configured to identify a node or nodes that match the matching criterion in the query region message 415, but can be further or alternatively configured to only include the identifiers of the nodes that are currently detected as active in the domain. Whether a node is active can be determined by “pinging” the node, a presence service can be used for providing a status of a node in the domain, and/or a node query response can be received in response to sending a node query response to the node. In another alternative, the multicast service 304 and/or nodes in the domain can identify one or more nodes that match the criteria in the query region message 415 and/or can be further configured to identify the node or nodes with a specified set of available resources such as storage, memory, processor capacity, etc. A query region message 415 can include a service identifier as a matching attribute.

In another aspect, sending the network identifier includes sending a query region response including a plurality of network identifiers each identifying a node having a node region at least partially present domain region. For example, the message-out handler component 208 component can be configured to send the network identifier by sending a query region response including a plurality of network identifiers each identifying a node having a node region at least partially present domain region.

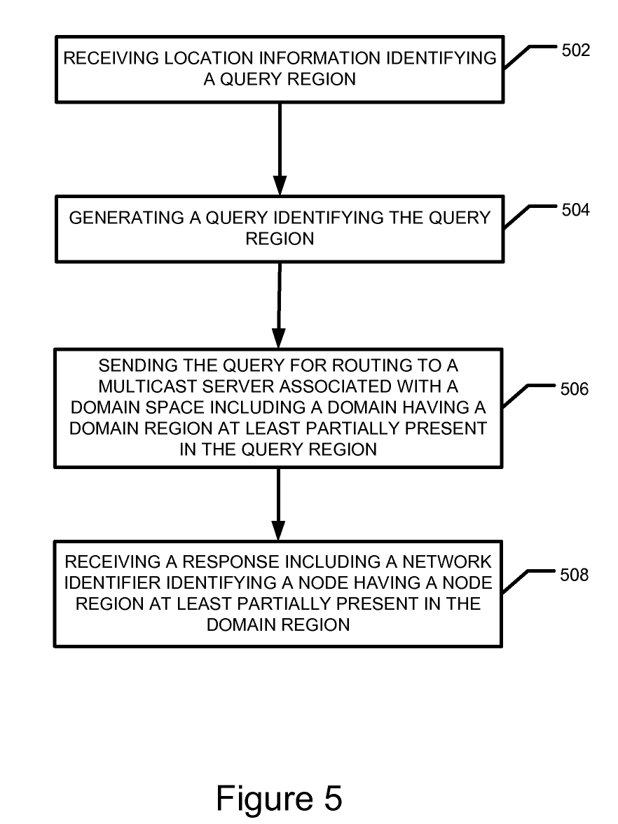

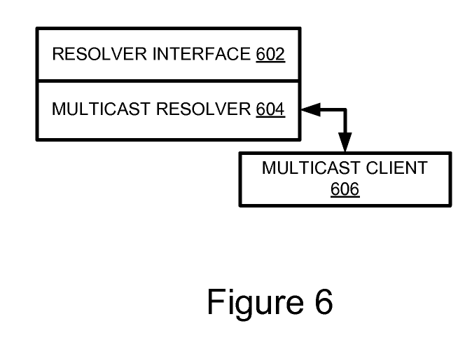

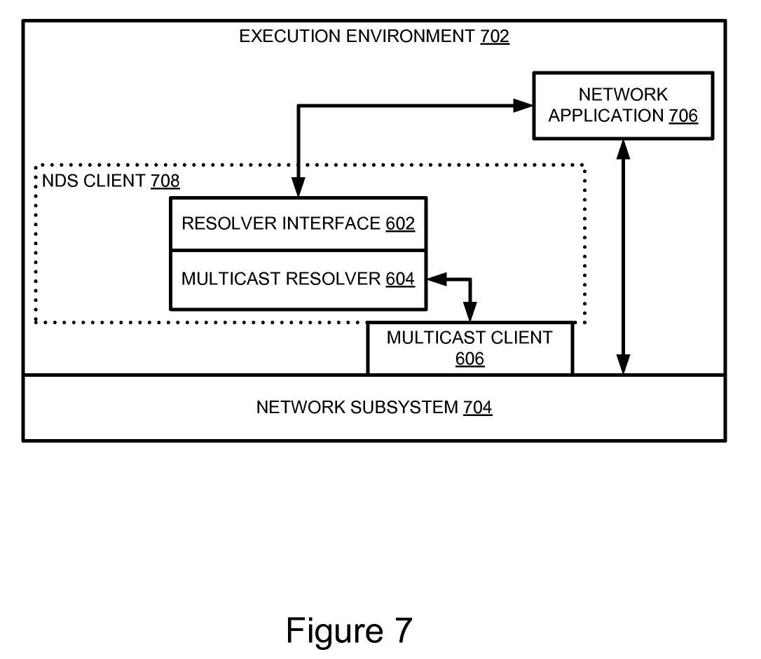

FIG. 5 is a flow diagram illustrating a method for resolving a query region to a network identifier according to an exemplary embodiment of the subject matter described herein. FIG. 6 is a block diagram illustrating an arrangement of components for resolving a query region to a network identifier according to another exemplary embodiment of the subject matter described herein. FIG. 7 is a block diagram illustrating an arrangement of components providing an execution environment configured to host the arrangement of components illustrated in FIG. 6. The method 500 illustrated in FIG. 5 can be carried out by, for example, some or all of the components illustrated in FIG. 6 operating in a compatible execution environment, such as the environment illustrated in FIG. 7.

With reference to FIG. 5, in block 502 location information identifying a query region is received. Accordingly, a system for resolving a query region to a network identifier includes means for receiving location information identifying a query region. For example, as illustrated in FIG. 6, a resolver interface component 602 is configured to receive location information identifying a query region.

Location information can include any of the forms and formats described above with respect to geospatial identifiers. Further, received location information can include a geospatial identifier that is a network identifier, such as a geospatial network address or a geospatial name corresponding to at least a portion of a network address.

According to an aspect, FIG. 7 illustrates the components of FIG. 6 including the resolver interface component 602 operating in an execution environment 702. The execution environment 702 can be any execution environment suitable for hosting the components illustrated in FIG. 6. For example, a typical execution environment can include a memory for storing instructions and data, a processor for processing the instructions and data, a control program or operating system for managing the memory and making the instructions and data accessible to the processor. The execution environment 702 can include any other subsystems required by any components for a particular configuration. For example, the execution environment 702 can include a network subsystem 704 configured to provide network communications in interoperation with at least some of the components operating in the execution environment 702. Execution environments can be provided by a node or a distributed execution environment can be provide by a collection of nodes. The second node 412 in FIG. 4 can provide the execution environment 702 hosting the resolver interface component 602.

The received location information can be received by the resolver interface component 602 from a network application 706 illustrated in FIG. 7. The network application 706 can receive the information. The network application 706 can be configured with location information. The network application 706 can identify the query region to a network directory system (NDS) client 708 configured to communicate with one or more network directory systems. The domain name system (DNS) is a NDS for mapping internet node names to internet network addresses and vice versa. The network application 706 can identify the query region to the resolver interface component 602 included in the NDS client 708 for receiving a network identifier, such as network address. The network application 706 can establish communication with an application operating in an execution environment 702 of the second node 412 in FIG. 4 via the network 410. Alternatively, the network application 706 can provide at least one of a geospatial network address and a geospatial name as the query region identifier to the resolver interface component 602 in the NDS client 708 for determining a network identifier in the form of a name corresponding to the geospatial network address.

Returning to FIG. 5, in block 504 a query is generated, The query identifies the query region. Accordingly, a system for resolving a query region to a network identifier includes means for generating a query identifying the query region. For example, as illustrated in FIG. 5, a multicast resolver component 604 is configured to generate a query identifying the query region.

The resolver interface component 602 provides the query region identifier to a multicast resolver component 604 configured to generate a query for sending to a multicast server node 402 hosting a multicast server 304 representing a domain, such as subnet or a naming domain, for resolving the location information to a network identifier. The second node 412 can obtain the address of the multicast server node 402 in a variety of ways. For example, the address can be locally configured, the second node 412 can use an identifier that includes the address (in a geospatial network), or the address can be obtained via any other directory/lookup service,

The node query message 425 illustrated in FIG. 4 can be for resolving the location information to a name of a node in a domain having a domain region represented by the multicast server 304. The location information, as discussed above, can be a geospatial address. The geospatial address can include a network identifier for resolving the geospatial identifier to a particular node in the domain identified by the domain portion of the geospatial address. Alternatively, the node portion of the geospatial address can be included in a matching expression for identifying any nodes with network interfaces in the identified domain. In one aspect, the absence of a node portion can result in matching all network identifiers in the domain identified by the domain portion.

Similarly, the location information can be a network identifier in the form of a name for resolving to a network address of at least one node included in a network domain identified by the domain portion of the location information. The node portion can be at least one of a name and a matching expression for matching one or more network interface names of nodes in the domain identified by the domain name portion of the geospatial network identifier.

Alternatively, the location information can identify a geospatial region that is received in the form of a network identifier. A network identifier in the form of a network interface name or address can be provided along with the location information for identifying a network identifier of a node associated with the network identifier. As described above, any matching expression for matching one or more attributes associated with a node in the identified domain can be received.

According to another aspect, the location information can be in the form of a matching expression for identifying one or more geospatial regions. When a domain portion of the received location information includes a matching expression, one or more network identifiers of multicast server nodes can be determined where the matching expression in the received location information matches a domain portion of a network address where each match identifies a domain served by one or more multicast server nodes.

The received location information can identify a geospatial query region where the location information is not a network identifier or a portion of a network identifier. In such an aspect, the network address for transmitting the query can be determined based on a domain space, were a domain in the domain space identifies a geospatial domain region. The message can be addressed to a multicast server node associated with a domain where the geospatial query region is at least partially present in the geospatial domain region. The domain can represent a subnet associated with the geospatial domain region or a network name domain associated with the geospatial domain region.

In another aspect, generating a query can include determining a group identifier of a multicast group associating a member with the domain, wherein the query includes the group identifier. For example, the multicast resolver component 604 can be configured to determine a group identifier of a multicast group associating a member with the domain, wherein the query includes the group identifier. In another aspect, determining the group identifier can be based on the received location information.

In another aspect, determining the group identifier includes sending a lookup message including information identifying the query region to a directory service; and receiving a response including the group identifier. For example, the multicast resolver component 604 can be configured to send a lookup message including information identifying the query region to a directory service; and receiving a response including the group identifier. For example, as described in application Ser. No. ______ (Attorney Docket No I522/US) filed on ______, entitled “METHODS AND SYSTEMS FOR RESOLVING A GEOSPATIAL QUERY REGION TO A NETWORK IDENTIFIER”, an NDS representing the domain space can maintain an association between the geospatial domain space and a domain from another domain space where a node in the other domain space has a node region at least partially included in the geospatial domain space. The NDS can return one or more domain identifiers from which one or more unicast addresses of multicast server nodes can be determined. Further, as described in application Ser. No. ______ (Attorney Docket No I522/US) filed on ______, entitled “METHODS AND SYSTEMS FOR RESOLVING A GEOSPATIAL QUERY REGION TO A NETWORK IDENTIFIER”, additional attributes associated with a domain and/or a node in a domain can be applied in a filter for selecting domain identifiers associated with the geospatial domain space from which unicast addresses can be based.

The query generated by the multicast resolver component 604 can identify a query region or regions based on the location information received from the resolver interface component 602. The query can optionally include a network identifier or matching expression based on any attributes for matching a node in a domain identified by geospatial region.

Returning to FIG. 5, in block 506 the query is sent for routing to a multicast server associated with a domain space including a domain having a domain region at least partially present in the query region. Accordingly, a system for resolving a query region to a network identifier includes means for sending the query for routing to a multicast server associated with a domain space including a domain having a domain region at least partially present in the query region. For example, as illustrated in FIG. 6, a multicast client component 606 is configured to send the query for routing to a multicast server associated with a domain space including a domain having a domain region at least partially present in the query region.

The multicast client component 606 can be configured to communicate with a multicast server node on behalf of various applications/components. The multicast resolver component 604 interoperates with the multicast client component 606 for sending the query to a multicast server node 402 for the domain identified based on the received location information. As described above, the query can include a network identifier or any other matching attribute(s) for matching a node in the subnet or domain identified by the unicast address.

The multicast client component 606 can be configured to establish communication with the multicast server 304 representing the identified subnet/domain 408 via a connection such as a Transmission Control Protocol (TCP) connection or via connectionless communication such as supported by User Datagram Protocol (UDP). The connection and/or connectionless communication can be established by a network protocol stack such as a TCP/IP stack including an Ethernet link layer and an Ethernet physical layer media. The network stack is included in a network subsystem 704 operating in the execution environment 702.

The execution environment 702 hosting the components illustrated in FIG. 6 can be provided by the second node 412. The components illustrated in FIG. 6 can be adapted for operating in the execution environment 702. The multicast client component 606 can be configured to send the generated query region message 415 via the network subsystem 704 to the network 410 for routing to the multicast server node 402 representing the domain having the domain region 408. The domain and the domain region are identifiable based on a unicast address. The unicast address can be determined based on the location information as described above. The multicast server node 402 provides for determining a network identifier of a node in the domain having the domain region 408 based on the message as described above. The multicast server node 402 further provides for transmitting a query region response 435 identifying a node in the domain having the domain region 408 matching the query, such as the first node 404. The query region response 435 to the query region message 415 is transported via the network 410 to the second node 412.

As described above, FIG. 4 illustrates the first node 404 having a node region 406. The first node 404 can be included in the node region 406 and/or can represent the node region 406 through another type of association. The association between a node and a node region can be based on any relationship between the node region and the node. The relationship can be of any type, be unidirectional or bidirectional, and can have cardinality. For example, the relationship associating a node with a node region can be of a type based on at least one of an owner, a user, an administrator, a domain and/or domain region including, a purchase of, a legal right associated with, an authentication service for, an authorization service for, a signer of a digital certificate for one or more of the node and the node region.

At least one of the matching conditions for determining a network identifier can be that the identified node has a node region at least partially included in the query region. One or more network identifiers can be included in the response, or one or more responses can be received from one or more domains as provided by a multicast server node of each domain. Each domain has a domain region at least partially including the query region.

Returning to FIG. 5, in block 508 a response including a network identifier identifying a node having a node region at least partially present in the domain region is received. Accordingly, a system for resolving a query region to a network identifier includes means for receiving a response including a network identifier identifying a node having a node region at least partially present in the domain region. For example, as illustrated in FIG. 6, the multicast client component 606 is configured to receive a response including a network identifier identifying a node having a node region at least partially present in the domain region.

The response identifying a node included in the domain is received by the multicast resolver component 604 via the multicast client component 606 as illustrated in FIG. 6. The multicast client component 606 can be configured to route messages from a multicast server node 402 to a component and/or application identified in the message.

Referring again to FIG. 7, the query region response 435 can be received by the network subsystem 704 from the network 410 and routed to the multicast client component 606 for routing. Alternatively, the query region response 435 can be addressed for routing by the network subsystem 704 to the multicast resolver component 604 bypassing the multicast client component 606. For example, the query region message 415 can identify a TCP/IP port opened by the network subsystem 704 on behalf of the multicast resolver component 604 for listening for the query region response 435 to the query region message 415. The port number can be included in the query region message 415 for addressing the query region response 435.

The network identifier can be returned to the network application 706 from the multicast resolver component 604 directly or via the resolver interface component 602 originally invoked by the network application 706. The network identifier of the first node 404 can be a network address allowing the network application 706 to establish communication with the first node 404 via the network 410. Alternatively, the returned network identifier can be a network name of the first node 404. The network name can be resolved to a network address for communicating with the first node 404. The network identifier as either a network address of a network name can be included in a URL for accessing a resource provided by the first node 404. Additionally or alternatively, the network identifier can be presented via a user interface to a user. For example, information related to the first node 404 can be presented in association with the query region, for example, on a map.

According to an aspect, in response to receiving the query region response 435, a message can be sent to the node, the message addressed with a destination network address based on the network identifier. For example, a network subsystem component 704 can be configured to, in response to receiving the query region response 435, sending a message to the identified node, the message addressed with a destination network address based on the network identifier.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for resolving a query region to a network identifier, the method comprising:
receiving, at a multicast server associated with a domain space including a domain having a domain region, a network identifier identifying a node having a node region at least partially present in the domain region;
receiving, at the multicast server, a query identifying a query region;
determining that the domain region is at least partially present in the query region;
sending the network identifier in response to the determination.

2. The method of claim 1 wherein the network identifier is included in a join message from the identified node.

3. The method of claim 2 wherein the join message identifies a resolution group for resolving the query region to the network identifier.

4. The method of claim 1 wherein the domain space is at least one of a network address space including a network address identifying a subnet as the first domain and a network name domain space including a network name identifying a naming domain as the domain, wherein the network name is resolvable to the network address and the network address is resolvable to the network name.

5. The method of claim 1 wherein the query is included in an asynchronous message.

6. The method of claim 1 wherein the query includes a geospatial identifier identifying the query region.

7. The method of claim 1 wherein the query includes a multicast server identifier identifying the multicast server.

8. The method of claim 1 wherein the query includes a multicast group identifier identifying a resolution service for processing the query.

9. The method of claim 8 wherein determining that the domain region is at least partially present in the query region includes:
routing, based on the multicast group identifier, a node query message to the resolution service;
receiving, from the resolution service, a node query response identifying the node.

10. The method of claim 1 wherein determining that the domain region is at least partially present in the query region includes:
determining a resolution service based on the query;
routing a node query message to the resolution service for determining whether the domain region is at least partially present in the query region; and
receiving a node query response identifying the node.

11. The method of claim 10 wherein the resolution service is hosted on a node hosting the multicast server.

12. The method of claim 1 wherein the query message is formatted according to a domain name system (DNS) protocol and the resolution service includes a network directory service.

13. The method of claim 1 wherein determining that the domain region is at least partially present in the query region includes determining that the query region is at least partially present in the node region.

14. The method of claim 1 wherein sending the network identifier includes sending a query response including a plurality of network identifiers each identifying a node having a node region at least partially present domain region.

15. A method for identifying a node having a node region at least partially present in a domain region, the method comprising:
receiving location information identifying a query region;
generating a query identifying the query region;
sending the query for routing to a multicast server associated with a domain space including a domain having a domain region at least partially present in the query region; and
receiving a response including a network identifier identifying a node having a node region at least partially present in the domain region.

16. The method of claim 15 wherein the domain space is a geospatial domain space having a geospatial identifier identifying the domain region.

17. The method of claim 15 wherein the domain space is a network identifier domain space having at least one of a subnet identifier identifying the domain and a network domain name identifying the domain, wherein the subnet identifier is resolvable to the domain name and the domain name is resolvable to at least a portion of the subnet identifier.

18. The method of claim 15 wherein generating a query includes determining a group identifier of a multicast group associating a member with the domain, wherein the query includes the group identifier.

19. The method of claim 18 wherein determining the group identifier is based on the received location information.

20. The method of claim 18 wherein determining the group identifier includes:
sending a lookup message including information identifying the query region to a directory service; and
receiving a response including the group identifier.

21. The method of claim 15 wherein the generated query is addressed based on an identifier of the query region.

22. The method of claim 15 wherein the domain region is at least partially present in a plurality of node regions associated with a plurality of nodes corresponding to a plurality of network identifiers included in the query response.

23. The method of claim 15 further comprising in response to receiving the query response, sending a message to the node, the message addressed with a destination network address based on the network identifier.

24. A system for resolving a query region to a network identifier, the system comprising:
means for receiving, at a multicast server associated with a domain space including a domain having a domain region, a network identifier identifying a node having a node region at least partially present in the domain region;
means for receiving, at the multicast server, a query identifying a query region;
means for determining that the domain region is at least partially present in the query region; and
means for sending the network identifier in response to the determination.

25. A system for resolving a query region to a network identifier, the system comprising:
a group manager component configured to receive, at a multicast server associated with a domain space including a domain having a domain region, a network identifier identifying a node having a node region at least partially present in the domain region;
a resolution service component configured to receive, at the multicast server, a query identifying a query region;
a matcher component configured to determine that the domain region is at least partially present in the query region;
a message-out handler component configured to send the network identifier in response to the determination.

26. The system of claim 25 wherein the network identifier is included in a join message from the identified node.

27. The system of claim 26 wherein the join message identifies a resolution group for resolving the query region to the network identifier.

28. The system of claim 25 wherein the domain space is at least one of a network address space including a network address identifying a subnet as the first domain and a network name domain space including a network name identifying a naming domain as the domain, wherein the network name is resolvable to the network address and the network address is resolvable to the network name.

29. The system of claim 25 wherein the query is included in an asynchronous message.

30. The system of claim 25 wherein the query includes a geospatial identifier identifying the query region.

31. The system of claim 25 wherein the query includes a multicast server identifier identifying the multicast server.

32. The system of claim 25 wherein the query includes a multicast group identifier identifying a resolution service for processing the query.

33. The system of claim 32 wherein the matcher component is configured to:
route, based on the multicast group identifier, a node query message to the resolution service; and
receive, from the resolution service, a node query response identifying the node.

34. The system of claim 25 wherein the matcher component is configured to:
determine a resolution service based on the query;
route a node query message to the resolution service for determining whether the domain region is at least partially present in the query region; and
receive a node query response identifying the node.

35. The system of claim 34 wherein the resolution service component is hosted on a node hosting the multicast server.

36. The system of claim 25 wherein the query message is formatted according to a domain name system (DNS) protocol and the resolution service component includes a network directory service component.

37. The system of claim 25 wherein the matcher component is configured to determine that the query region is at least partially present in the node region.

38. The system of claim 25 wherein the message-out handler component is configured to send the network identifier includes sending a query response including a plurality of network identifiers each identifying a node having a node region at least partially present domain region.

39. A system for identifying a node having a node region at least partially present in a domain region, the system comprising:
means for receiving location information identifying a query region;
means for generating a query identifying the query region;
means for sending the query for routing to a multicast server associated with a domain space including a domain having a domain region at least partially present in the query region; and
means for receiving a response including a network identifier identifying a node having a node region at least partially present in the domain region.

40. A system for identifying a node having a node region at least partially present in a domain region, the system comprising:
a resolver interface component configured to receive location information identifying a query region;
a multicast resolver component configured to generate a query identifying the query region;
a multicast client component configured to send the query for routing to a multicast server associated with a domain space including a domain having a domain region at least partially present in the query region; and
a multicast client component configured to receive a response including a network identifier identifying a node having a node region at least partially present in the domain region.

41. The system of claim 40 wherein the domain space is a geospatial domain space having a geospatial identifier identifying the domain region.

42. The system of claim 40 wherein the domain space is a network identifier domain space having at least one of a subnet identifier identifying the domain and a network domain name identifying the domain, wherein the subnet identifier is resolvable to the domain name and the domain name is resolvable to at least a portion of the subnet identifier.

43. The system of claim 40 wherein the multicast resolver component is configured to determine a group identifier of a multicast group associating a member with the domain, wherein the query includes the group identifier.

44. The system of claim 43 wherein the multicast resolver component is configured to determine the group identifier based on the received location information.

45. The system of claim 43 wherein the multicast resolver component is configured to send a lookup message including information identifying the query region to a directory service; and receiving a response including the group identifier.

46. The system of claim 40 wherein the multicast resolver component is configured to address the generated query based on an identifier of the query region.

47. The system of claim 40 wherein the domain region is at least partially present in a plurality of node regions associated with a plurality of nodes corresponding to a plurality of network identifiers included in the query response.

48. The system of claim 40 further comprising a network subsystem component configured to, in response to receiving the query response, send a message to the node, the message addressed with a destination network address based on the network identifier.

49. A computer readable medium embodying a computer program, executable by a machine, for resolving a query region to a network identifier, the computer program comprising executable instructions for:
receiving, at a multicast server associated with a domain space including a domain having a domain region, a network identifier identifying a node having a node region at least partially present in the domain region;
receiving, at the multicast server, a query identifying a query region; and
determining that the domain region is at least partially present in the query region;
sending the network identifier in response to the determination.

50. A computer readable medium embodying a computer program, executable by a machine, for identifying a node having a node region at least partially present in a domain region, the computer program comprising executable instructions for:
receiving location information identifying a query region;
generating a query identifying the query region;
sending the query for routing to a multicast server associated with a domain space including a domain having a domain region at least partially present in the query region;
receiving a response including a network identifier identifying a node having a node region at least partially present in the domain region.
